(19) United States
(12) Patent Application Publication
(10) Pub. No.: US 2012/0054336 A1
(43) Pub. Date: Mar. 1, 2012

(54) MANAGEMENT OF CONTENT DELIVERY NETWORKS BASED ON CAMPAIGN PERFORMANCE

(75) Inventors: Eswar Priyadarshan, West Roxbury, MA (US); Kenley Sun, Cambridge, MA (US); Dan Marius Grigorovici, Pleasanton, CA (US); Jayasurya Vadrevu, Lexington, MA (US)

(73) Assignee: Apple Inc., Cupertino, CA (US)

(21) Appl. No.: 12/873,277

(22) Filed: Aug. 31, 2010

(51) Int. Cl. G06F 15/173

(52) U.S. Cl. 709/224

(57) ABSTRACT

The process of constructing a successful targeted content campaign can be time consuming and error prone. By having access to performance data, adjustments can be made, such as to the tasks performed by the content delivery system, the available content, or the campaign parameters, to improve performance. As the delivery system performs its tasks, it can collect a variety of information regarding the activities within the delivery system. Based on the collected information, the delivery system can obtain performance data for the various campaigns. The delivery system can then analyze the performance data to identify any campaigns that have failed to meet the specified performance criteria. When a non-conforming campaign is detected, the delivery system can attempt to determine the cause of the non-conformance and send an alert to the appropriate entity. Additionally, in some cases, the delivery system can include in the alert suggestions for improving the campaign performance.

### BACKGROUND

1. Technical Field

The present disclosure relates to monitoring the performance of a content delivery system and more specifically to automatically detecting non-conforming campaigns within a content delivery system and generating an alert regarding such non-conformance.

2. Introduction

Targeted content delivery has long been an accepted means of conveying a desired message to an audience. Instead of creating a single message and delivering it to every member of the general public, content providers will attempt to identify a segment of the population that is likely to have the greatest interest in the message. The content providers may also shape the message so that it has the greatest appeal to those in the targeted population segment and attempt to identify the most effective channel over which to deliver the message. The process of constructing a successful campaign consisting of a message, channel, and/or a population segment is often a trial and error process that involves trying a combination of parameters, observing the results, adjusting the parameters, observing the results and repeating. Such a process can be time consuming and error prone. This process is further complicated in an electronic content delivery system where information is constantly changing.

In order to make adjustments to targeted content campaigns, a content provider needs access to relevant performance data. However, simply having access to the data is insufficient if the data is not received, reviewed, and correctly interpreted in a timely manner. Any delay and/or misunderstanding can be costly to the content providers as well as the content delivery system, as they are all likely to generate revenue based on the success of a targeted content campaign.

### SUMMARY

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

The present technology provides mechanisms for analyzing performance of electronic campaigns in a network associated with a content delivery system, detecting when the performance has failed to meet a specified performance criteria, and generating alerts regarding the non-conformance for entities associated with one or more elements in the network.

As a content delivery system operates, it can collect a variety of information related to the tasks and the activities within the system. These activities can include the processing of campaign goals, the processing of requests for invitational content, past campaigns, and active campaigns, as well as any other activity that takes place within the delivery system. Based on this information or an analysis thereof, the delivery system can compile performance data for the various campaigns submitted by content providers.

The performance data can be useful in indicating whether a particular campaign is meeting the established performance criteria or whether adjustments are required for the campaign, the content, or elements in the network associated with the campaign. However, such information is only useful if interpreted correctly and in a timely manner. To that end, a system monitoring the network, such as the content delivery system, can periodically analyze the performance data to identify non-conforming campaigns. A variety of methods can be used to identify a non-conforming campaign, such as comparing the performance data to past similar campaigns, estimates, stated goals, previous time periods for the same campaign, etc.

Once the delivery system has identified a non-conforming campaign, the delivery system can perform further analysis to identify why the campaign is not performing as expected. This analysis could reveal one or more factors ranging from inappropriate invitational content or targeted segment associated with the campaign, to improper population segmentation or segment prioritization, or even an unrealistic specified performance criteria. The source of the non-conformance helps the delivery system determine to which entity to send an alert. For example, if the delivery system concludes that a campaign is non-conforming because a very narrowly defined segment is associated with the campaign, the delivery system can generate an alert for the content provider responsible for the submitting the campaign. Alternatively, if the source is the result of the analysis used to assign users to a population segment, the delivery system can generate an alert for an administrator of the delivery system.

In some embodiments, once the delivery system has determined the cause of a non-conforming campaign, the delivery system can make suggestions for improving the performance. For example, if the source is a narrowly defined targeted segment associated with the campaign, the delivery system could suggest alternative segments or adjustments to the segment that could lead to a high probability of achieving the campaign goal. Alternatively, if the source is the pairing of primary and secondary content, the delivery system could suggest an administrator verify the algorithm used to attach contextual information to the primary content or possibly even suggest secondary content that would be a better match. Such suggestions could be based on simulations or predictive analysis or by comparing with previously successful campaigns. Any suggestions can be included in the alert generated for the entity.

### BRIEF DESCRIPTION OF THE DRAWINGS

In order to describe the manner in which the above-recited and other advantages and features of the disclosure can be obtained, a more particular description of the principles briefly described above will be rendered by reference to specific embodiments thereof, which are illustrated in the appended drawings. Understanding that these drawings depict only exemplary embodiments of the disclosure, and are not therefore to be considered to be limiting of its scope, the principles herein are described and explained with additional specificity and detail through the use of the accompanying drawings in which:

FIG. 1 illustrates an exemplary configuration of devices and a network;

FIG. 2 illustrates an exemplary method configuration for identifying a non-conforming campaign;

FIG. 3 illustrates an exemplary method configuration for suggesting a change to improve the performance of a non-conforming campaign;

FIG. 4 illustrates an exemplary user interface for a non-conforming campaign alert; and

FIG. 5 illustrates an example system embodiment.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure. The present disclosure addresses the need in the art for improved methods of selecting targeted content presented to a user based on characteristics descriptive of the user and/or the user's interaction with one or more items of targeted content.

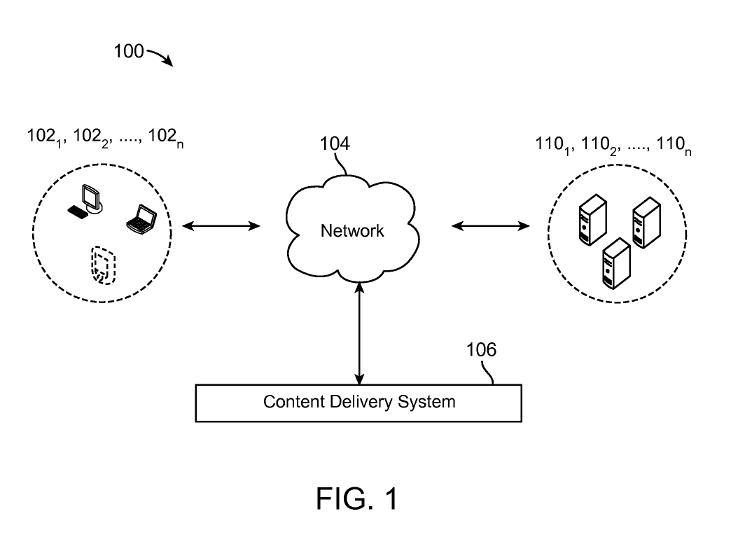

The presently disclosed system and method is particularly useful for analyzing the performance of a content delivery system, detecting when the performance fails to meet a specified performance criterion, and generating an alert regarding the non-conformance. An exemplary system configuration 100 is illustrated in FIG. 1, wherein electronic devices communicate via a network for purposes of exchanging content and other data. The system can be configured for use on a local area network, such as that illustrated in FIG. 1. However, the present principles are applicable to a wide variety of network configurations that facilitate the intercommunication of electronic devices. For example, each of the components of system 100 in FIG. 1 can be implemented in a localized or distributed fashion in a network.

In system 100, the content delivery system 106 interacts with content providers 110₁ . . . 110ₙ (collectively “110”) and user terminals 102₁ . . . 102ₙ (collectively “102”), via direct and/or indirect communication, to facilitate the transfer of invitational content from the content providers 110 to the user terminals 102. Any number or type of user terminals 102 can interact with the delivery system 106. For example, a user terminal 102 can be a desktop computer; a laptop computer; a handheld communication device, e.g. mobile phone, smart phone, tablet, or any other type of device connecting using multiple or non-persistent network sessions; etc.

In the various embodiments, the invitational content can include text, graphics, audio, video, executable code or any combination thereof. In some embodiments, the invitational content can be associated with a product or can directly or indirectly advertise a product. The invitational content can include content designed to inform or elicit a pre-defined response from the user and/or content that can vary over time. For example, invitational content can include one or more types of advertisements from one or more advertisers. Further, the invitational content can be active invitational content in that it is designed to primarily elicit a pre-defined response from the user. For example, active invitational content can include one or more types of advertisements configured to be clicked upon, solicit information, or be converted by the user into a further action, such as a purchase or download of the advertised item. However, invitational content can also include passive invitational content that is designed to primarily inform the user. In some cases, passive invitational content can include information that can lead or direct users to active invitational content. Additionally, the invitational content can be dynamic invitational content. That is, invitational content that varies over time or that varies based on user interaction with the invitational content. Alternatively, the invitational content can be static invitational content that does not vary over time and does not vary based on user interaction. In the various embodiments, invitational content can be static or dynamic and active or passive. Further, various types of invitational content can be combined.

One form of interaction between the delivery system 106 and a user terminal 102 can be a request for invitational content from one of the user terminals 102. A user terminal 102 can also provide the delivery system 106 with user characteristic data. This data can be maintained and updated over time based on repeated interaction with the delivery system 106 to aid the delivery system 106 in selecting invitational content that is of greater interest to the user.

Furthermore, in addition to the user characteristic data provided directly by a user terminal 102, the delivery system 106 can learn other user characteristics. Some of the user characteristics can be learned by inferring/deriving characteristics from other information known to the delivery system 106. For example, the delivery system 106 can infer a user characteristic value by comparing one or more user characteristic values with a database of data and then inferring the user characteristic value from the comparison. The delivery system 106 can also infer a user characteristic value by comparing the user characteristic data associated with the user with a collection of user characteristic values collected from a population of users. Using this method, the delivery system can identify other users with similar values and substitute their values for the unknown values of the user. Additionally, there are some characteristics that the delivery system 106 can infer from other user characteristics know about the user. For example, the delivery system 106 may be able to derive a user's gender from a known preferred salutation, first name, and/or purchase history.

As used herein, the term “user characteristics” refers to data descriptive of the user and/or the user's interactions with one or more items of invitational content. User characteristics can include channel, demographic, behavioral, and/or spatial-temporal characteristics. Channel characteristics can define the specific delivery channel being used to deliver a content package to a user. For example, channel characteristics can include a type of electronic content, a type of device or user terminal, a carrier or network provider, or any other characteristic that defines a specific delivery channel for the content package. Spatial-temporal characteristics can define a location, a date, a time, or any other characteristic that defines a geographic location and/or a time for delivery of the content package. Demographic characteristics can define characteristics of the users targeted by the content or associated with the content. For example, demographic characteristics can include age, income, ethnicity, gender, occupation, or any other user characteristics. Behavioral characteristics can define user behaviors for one or more different types of content, separately, or in combination with, any other user characteristics. That is, different behavioral characteristics may be associated with different channel, demographic, or spatial-temporal characteristics. User characteristics can also include characteristics descriptive of a user's state of mind, including characteristics indicative of how likely a user is to click on or convert an item of invitational content if it were displayed to the user.

An important interaction between a content provider 110 and the content delivery system 106 can be the submission of a campaign by one of the content providers 110. A campaign can specify one or more targeted segments and a target objective. A targeted segment specified by a content provider 110 can be selected from a set of predefined segments contained within the delivery system 106 or created specifically for the content provider 110 by defining the segment from scratch or modifying a previously defined segment. A targeted segment can be defined based on one or more user characteristics or derivatives thereof, and can be associated with one or more items of invitational content. By specifying a targeted segment, the content provider 110 is requesting that the associated invitational content is only delivered to users that satisfy the requirements of the targeted segment. The delivery system 106 can assign a user to a segment by matching the user characteristics in the targeted segment with the characteristics of the user. The association of both a user and an item of invitational content facilitates matching invitational content with users.

A target objective can be expressed in several ways. For example, the target objective can specify a maximum budget not to be exceeded, or it can specify a performance metric, such as a click-through rate (CTR), an effective cost-per-thousand-impressions (eCPM), a target conversion rate, a target fill rate, or a desired period of user engagement, to name a few. Further, any combination of target objectives can be specified to define the overall target objective for the campaign, such as both a maximum budget and a CTR.

Ultimately, the content delivery system 106 is responsible for selecting and delivering invitational content to a user in response to a request made by that user. Such a task can be accomplished in a straightforward manner by simply selecting any content available at the time of request and sending it to the requesting user. While such an approach will fulfill the ultimate goal, it likely will result in delivering invitational content that is of little or no interest to the user and unsatisfied campaigns.

To increase the probability of selecting invitational content that will result in the user completing the associated conversion action and/or of satisfying the campaign target objectives, the content delivery system 106 can perform a variety of other tasks prior to selecting the content. These tasks can include, but are not limited to, processing campaign goals submitted by content providers 110; collecting data descriptive of the user and the user's interactions with invitational content; deriving or inferring user characteristics from other known information; keeping track of content previously presented to the user; analyzing the user characteristics to assign the user to one or more targeted segments; re-shaping content based on the user characteristics, so that it is in a form more likely to be accepted by the user; and prioritizing segments assigned to the user based on user context, content provider goals, and/or delivery system goals.

Each task performed by the delivery system 106 can contribute to the overall performance and success of the campaigns submitted by the content providers 110. For example, if the delivery system 106 improperly derives user characteristics, the user could be assigned to a targeted segment that does not accurately reflect the user's interests and/or intentions. Alternatively, if the delivery system 106 improperly re-shapes the content, the re-shaped content may actually be of less interest than the original content. In some embodiments, the delivery system 106 can analyze the performance of a campaign and determine whether one of the tasks performed by the delivery system 106 is contributing to non-conforming campaign. Based on the analysis, the delivery system 106 can alert an administrator of the delivery system 106 and possibly provide feedback, so that appropriate adjustments can be made.

From a content provider's perspective, if a campaign specifies an improper targeted segment or target objective or the associated invitational content is not of interest to the users assigned to the targeted segment, the performance of the campaign could fail to meet one or more specified performance criteria. For example, if the targeted segment is too narrow, the associated item of invitational content may be delivered to very few users, if any. Conversely, if the targeted segment is too broad, the invitational content may be delivered to users with little interest in the content. In some embodiments, the delivery system 106 can analyze the performance of a campaign and provide feedback to the content provider 110. The feedback can enable the content provider 110 of non-conforming campaign to make adjustments that may improve the performance of the campaign in the future.

In some cases, in response to a request for invitational content made by a user terminal 102, the delivery system 106 pairs primary and secondary content. The primary and secondary content can be provided by the same content provider 110 or multiple content providers 110. The primary content can be the base content that has dedicated space for the placement of secondary content. For example, primary content could be a web page or an application. Secondary content can be invitational content, and the pairing of primary and secondary content can vary over time. For example, at time t1 a user terminal 102 could make a request for content, and this request could be associated with the primary content application A. In response to the request, the delivery system 106 could select secondary content s1 for the pairing. At a later time t2, the same user terminal could again make a request for content that is again associated with primary content application A. In response, the delivery system 106 could, this time, select secondary content s2. In some cases, the delivery system 106 obtains information or rules to aid in selecting appropriate secondary content for a given item of primary content. For example, the primary content may contain tags or metadata that provide contextual information about the content. In the absence of specific rules for pairing primary and secondary content, the delivery system 106 can use the contextual information to identify invitational content that is an appropriate match for the primary content. Alternatively, the delivery system 106 could analyze the content to determine the contextual information. The obtained information or rules, whether provided by the content providers 110 or obtained by the delivery system 106 in some other manner, can impact the overall performance of the campaigns submitted by the content providers 110.

As described above, one aspect of the present technology is the gathering and use of data available from various sources to improve the delivery of advertisements or any other content that may be of interest to users. The present disclosure contemplates that, in some instances, this gathered data may include personal information data that uniquely identifies or can be used to contact or locate a specific person. Such personal information data can include demographic data, location-based data, telephone numbers, email addresses, twitter ID's, home addresses, or any other identifying information.

The present disclosure recognizes that the use of such personal information data in the present technology can be used to the benefit of users. For example, the personal information data can be used to better understand user behavior, facilitate and measure the effectiveness of advertisements, applications, and delivered content. Accordingly, use of such personal information data enables calculated control of the delivered content. For example, the system can reduce the number of times a user receives a given ad or other content and can thereby select and deliver content that is more meaningful to users. Such changes in system behavior improve the user experience. Further, other uses for personal information data that benefit the user are also contemplated by the present disclosure.

The present disclosure further contemplates that the entities responsible for the collection, analysis, disclosure, transfer, storage, or other use of such personal information data should implement and consistently use privacy policies and practices that that are generally recognized as meeting or exceeding industry or governmental requirements for maintaining personal information data private and secure. For example, personal information from users should be collected for legitimate and reasonable uses of the entity and not shared or sold outside of those legitimate uses. Further, such collection should occur only after the informed consent of the users. Additionally, such entities would take any needed steps for safeguarding and securing access to such personal information data and ensuring that others with access to the personal information data adhere to their privacy and security policies and procedures. Further, such entities can subject themselves to evaluation by third parties to certify their adherence to widely accepted privacy policies and practices.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of advertisement delivery services, the present technology can be configured to allow users to select to “opt in” or “opt out” of participation in the collection of personal information data during registration for services. In another example, users can select not to provide location information for advertisement delivery services. In yet another example, users can configure their devices or user terminals to prevent storage or use of cookies and other mechanisms from which personal information data can be discerned. The present disclosure also contemplates that other methods or technologies may exist for blocking access to their personal information data.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, content can be selected and delivered to users by inferring preferences based on non-personal information data or a bare minimum amount of personal information, such as the content being requested by the device associated with a user, other non-personal information available to the content delivery services, or publically available information.

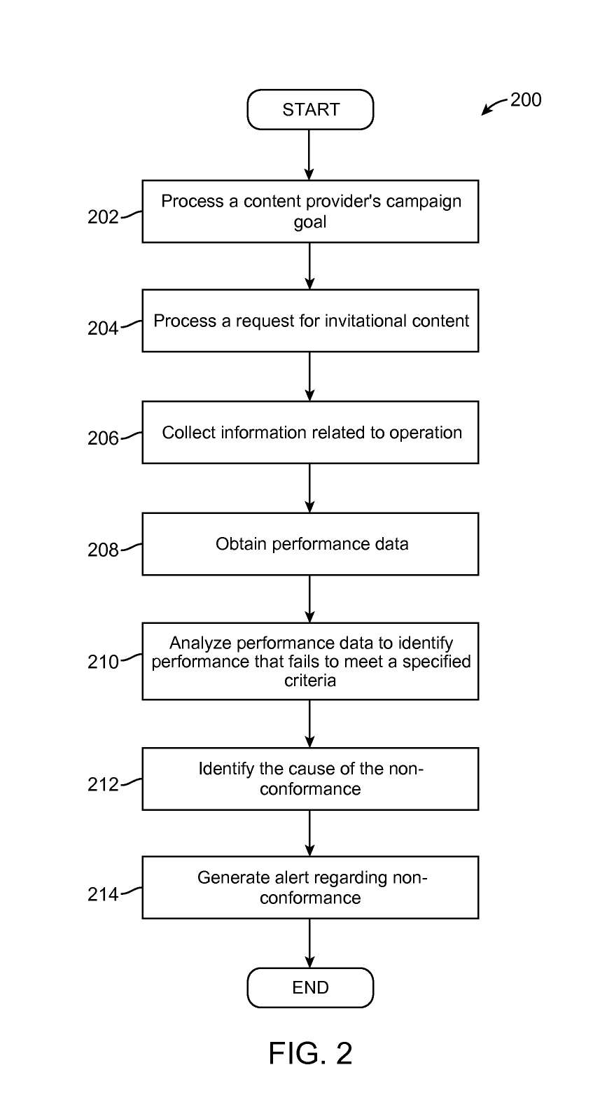

FIG. 2 is a flowchart illustrating steps in an exemplary method 200 for analyzing campaign performance, detecting when the performance has failed to meet a specified performance criterion, and generating an alert regarding the non-conformance. For the sake of clarity, this method is discussed in terms of an exemplary system such as is shown in FIG. 1. Although specific steps are shown in FIG. 2, in other embodiments, a method can have more or less steps than shown.

At various points in the operation of the content delivery system 106, the delivery system 106 processes a campaign goal submitted by a content provider 110 (202). As described above, a content provider 110 can submit a campaign to the delivery system 106. As part of the campaign, the content provider 110 can specify one or more targeted segments, target objectives, and items of invitational content. The information specified in the campaign aids in selecting the items of invitational content to deliver to user terminals 102.

Periodically, the content delivery system 106 processes a request for invitational content (204). Either prior to receiving the request, or as part of the processing of the request, the delivery system can obtain user characteristic data. As described above, the user characteristic data can be data descriptive of the user and the user's interactions with invitational content. Based on the user characteristic data, the delivery system 106 can assign the user to one or more targeted segments associated with active campaigns. The segment assignments can occur prior to receiving the request for content and/or as part of the processing of the request. The delivery system 106 can then select invitational content to deliver to the user based on the segment assignments.

Steps 202 and 204 occur repeatedly throughout the operation of the content delivery system 106. In some embodiments, as the delivery system 106 operates, a variety of information related to steps 202 and 204, past campaigns, active campaigns, and/or various activities within the delivery system 106 is collected (206). The information can be maintained in a variety of forms, e.g. statistics, metrics, collections, etc. For example, the delivery system 106 can maintain statistics regarding the click-through rate for a particular campaign, the number of users assigned to a particular segment, the length of time a campaign has been active, the duration of a completed campaign, the number of active campaigns associated with a particular content provider, etc. The data can also be categorized. For example, in some embodiments, the information can be related to behavioral information validation, operational information data validation, feature rollout validation, or partner specific validation.

In some embodiments, behavioral information validation data can be used to evaluate the accuracy of the user characteristics and/or the segment assignments. As described above, the user characteristic data can be obtained over time and from a variety of different sources. Because of this, there can be a number of sources of possible inaccuracies. For example, a single user can interact with the delivery system 106 via multiple user terminals 102 and/or multiple connections. In some embodiments, the delivery system 106 can attempt to identify that all connections belong to the user. If the system improperly associates two connections, or fails to associate two connections, then the user characteristic data may not accurately reflect the interests and/or intent of the user. Other sources of inaccuracies include the inferred/derived user characteristics; confidence scores assigned to inferred/derived characteristics or segment assignments; old data that can skew analysis of the user's interests and/or intent, e.g. in the past, the user purchased a significant amount of music from a particular genre, but has not purchased from that genre in a specified period of time; anomalous data; etc. These inaccuracies can lead to inaccuracies in segment assignment and/or a non-conforming campaign.

In addition to the accuracy of the user characteristics influencing the accuracy of the segment assignments, assigning a user to a targeted segment can involve analyzing user characteristic data to identify user interests and/or intent. Any inaccuracies in this analysis can cause inaccurate segment assignments.

In some embodiments, the operational data information validation data can be used to evaluate the accuracy of the segment definitions, the billing, the booking, the classification of the primary and secondary content, device inclusion/exclusion, carrier inclusion/exclusion, etc. For example, contextual information can be associated with primary content. That information can be used by the delivery system 106 to select appropriate invitational content to pair with the primary content. If the contextual information is inaccurate then invitational content could be paired that is of little or no interest to the user.

In some embodiments, the feature rollout validation data can be used to evaluate post-release behavior. For example, post-release data can be used to verify that any data formats or outputs are what they should be given the implementation.

In some embodiments, the partner-specific validation data can be used to evaluate the effectiveness of a campaign submitted by a content provider. For example, the delivery system 106 can collect data that can help identify that the targeted segment, associated invitational content, or target objective, are not ideal, and that adjustments could lead to improved performance of the campaign. Partner-specific validation data can also be used to evaluate the validity of requests made from user terminals and/or content providers.

At step 208, the delivery system 106 obtains data related to the performance of one or more campaigns. The performance data can be compiled directly from the information collected by the delivery system 106 in step 206, and/or it can be based on an analysis of the information from step 206. The frequency of obtaining the performance data can vary with the configuration of the system. In some configurations, the delivery system 106 can obtain the performance data at regular intervals, such as once a week, once a day, every 6 hours, etc. Alternatively, obtaining the performance data can be the result of an explicit request for the data, or can be triggered by some other activity in the delivery system. For example, step 208 could be triggered by a campaign reaching a specified time marker, e.g. the half-way point; a campaign reaching its associated target objective; a specified percentage of the total users being assigned to a single segment; the delivery system 106 processing a specified number of requests for invitational content; etc.

The performance data can be specific to a particular window of time, such as the previous 24 hours. The selected time window can vary with the configuration of the delivery system 106. In some configurations, multiple time windows can be specified, e.g. the previous 48 hours and the previous 24 hours. Furthermore, different time windows can be specified for different aspects of the performance data. For example, the delivery system 106 could obtain performance data related to behavioral information validation for the previous 12 hours, but the time window specific to data related to operational information data validation could be for the previous 24 hours.

After obtaining the performance data in step 208, the delivery system 106 analyzes the data to identify any campaigns that are non-conforming (210). The delivery system 106 can employ a variety of methods to detect non-conforming campaigns. In some embodiments, the delivery system 106 can analyze the performance data by identifying one or more similar campaigns from the set of past campaigns and comparing the performance data with performance data from the past campaigns. The past campaigns can be categorized as under-, average-, or over-performing campaigns. When the current performance data is compared to the past non-conforming campaigns, the delivery system 106 may also consider the current campaign non-conforming.

In some embodiments, the delivery system 106 can analyze the performance data by comparing it with estimates for campaign performance. The estimates can be for the life of the campaign or for a specific period of time during the campaign. For example, a performance estimate could be provided for the sixth hour of the campaign or the half-way point. The estimates could be provided at the beginning of the campaign, or the estimates could be based on a prediction of expected performance based on an analysis of the performance of the campaign over a period time. If the time period associated with the estimate coincides with the time period for the performance data, the delivery system 106 can use this information to identify a non-conforming campaign.

In some embodiments, the delivery system 106 can analyze the performance data by comparing it with stated goals. The goals can be provided by the content provider responsible for submitting the campaign or the delivery system 106. For example, a stated goal can be a particular number of click-throughs, conversions, or impressions in a specified period of time. If the stated goal has not been reached at the specified time period, the delivery system 106 may consider the campaign non-conforming. Alternatively, if a stated goal has been exceeded or reached too quickly, the delivery system 106 may consider the campaign non-conforming. For example, suppose a campaign establishes a target objective that includes a desired campaign duration and a maximum number of impressions. If the campaign has a high number of impressions early in the campaign, it is likely to end too early. In this case, the delivery system 106 may consider the campaign non-conforming, so that adjustments can be made to the campaign and/or the tasks performed by the delivery system 106.

In some embodiments, the delivery system 106 can analyze the performance data by comparing the data with performance data from other time periods for the same campaign. For example, if the performance data for the first six hours of the campaign indicate a steady rate of conversion, but hours 6-12 have very few conversions, the delivery system 106 may consider the campaign non-conforming.

In some embodiments, the delivery system 106 can use multiple methods to identify a non-conforming campaign. For example, the delivery system 106 may use stated goals, estimates based on past performance of the current campaign, and past performance of similar campaigns. In this case, if the delivery system 106 determines that the campaign has not reached the stated goal, the delivery system 106 can look to the estimates and performance of other similar campaigns to determine whether the stated goal was in fact achievable. If the delivery system 106 determines the stated goal was not achievable, the delivery system 106 may not flag the campaign as non-conforming. However, if the delivery system 106 does flag the campaign as non-conforming, the delivery system could use this information in step 212 below to help identify the cause of the non-conformance and possibly generate an alert indicating that, based on estimates, the stated goal may not be achievable.

When the delivery system 106 identifies a non-conforming campaign, the delivery system 106 can attempt to identify the cause of the non-conformance (212). In some cases, identifying the cause may be straightforward, because a single statistic has failed to meet an expected value, and that statistic is directly correlated with a single parameter. For example, the analysis may indicate that the same item of invitational content has been delivered multiple times to one or more users who have already completed the associated conversion action. From this, the delivery system 106 may be able to determine that the feature preventing duplicate delivery is not performing as expected.

In some cases, performance data from multiple time periods is available. In this case, the delivery system 106 can compare the data to identify changes. In other cases, identifying the cause may be more complex and even require further analysis or running simulations. For example, suppose the delivery system 106 detects that a fewer number of users have been assigned to a particular segment than expected. The cause could be that the segment definition is very narrow, and there simply are not many users who fit within the definition. Alternatively, this could indicate that the delivery system 106 is improperly analyzing the user characteristics. A further analysis of the segment definition could aid in determining the cause. If the segment is defined based strictly on user characteristics that do not require the delivery system 106 to perform further analysis, or were not inferred/derived by the delivery system 106, e.g. some demographic characteristics, then the delivery system 106 may be able to conclude that the cause is a narrowly defined targeted segment. Alternatively, if assigning the user to the segment requires the delivery system 106 to analyze the user's behavior over a period of time to infer one or more user characteristics, e.g. analyzing purchase or location history, then the delivery system 106 may be able to conclude that the cause is an error in the analysis, and that the algorithms used for the analysis require further tweaking.

In some cases, the behavioral, operational data, feature rollout, and partner specific validation data can be used to determine the cause of the non-conforming campaign performance. For example, the delivery system 106 can be configured such that pre-configured suggestions are associated with different validation categories or sub-categories. In some cases, the delivery system 106 supports user-provided suggestions or automatically generated suggestions as input to an algorithm that randomizes the suggestions over the campaign. The suggestions can be used on a subset of the campaign traffic and the delivery system 106 can automatically identify and turn on and off non-performing suggestions. Possible algorithms used can include, but are not limited to, neural network, genetic algorithms, fractional factorial testing, etc.

Finally, the delivery system 106 generates an alert regarding the non-conformance (214). In some embodiments, the delivery system 106 can generate an alert that simply indicates performance of a particular campaign has failed to meet specified criteria. The alert can be sent to the appropriate party depending on the determined cause of the non-conformance, e.g. a primary content provider, a secondary content provider, a system administrator, a sales associate for which the content provider is a client. For example, if the non-conformance is caused by an inaccuracy in assigning users to segments, the delivery system 106 can generate an alert for a system administrator of the delivery system 106. Alternatively, if the non-conformance is the result of using a segment too narrowly defined, the delivery system 106 can generate an alert directed to the content provider responsible for submitting the associated campaign. In yet another example, if the non-conformance is the result of improper contextual information being associated with the primary content, the delivery system 106 can generate an alert directed to the provider of the contextual information. For example, if the contextual information was obtained through tags or metadata associated with the content, the delivery system 106 can generate an alert for the primary content provider. In some cases, the delivery system 106 can determine the alert receiving entity based on the validation category. For example, if the non-conformity is related to the partner specific validation data, the delivery system 106 may be configured to generate an alert for a content provider.

In some embodiments, an alert can be sent to multiple recipients. For example, an alert indicating non-conformance due to a campaign parameter, such as the targeted segment, could be sent to the content provider responsible for submitting the campaign as well as a sales associate responsible for managing the account of that content provider. In the case of improper contextual information being associated with the primary content, the delivery system 106 may need to generate an alert for both an administrator of the content delivery system 106 and the primary content provider. In could occur if the contextual information provided by the primary content provider does match with any analysis of the content performed by the delivery system 106.

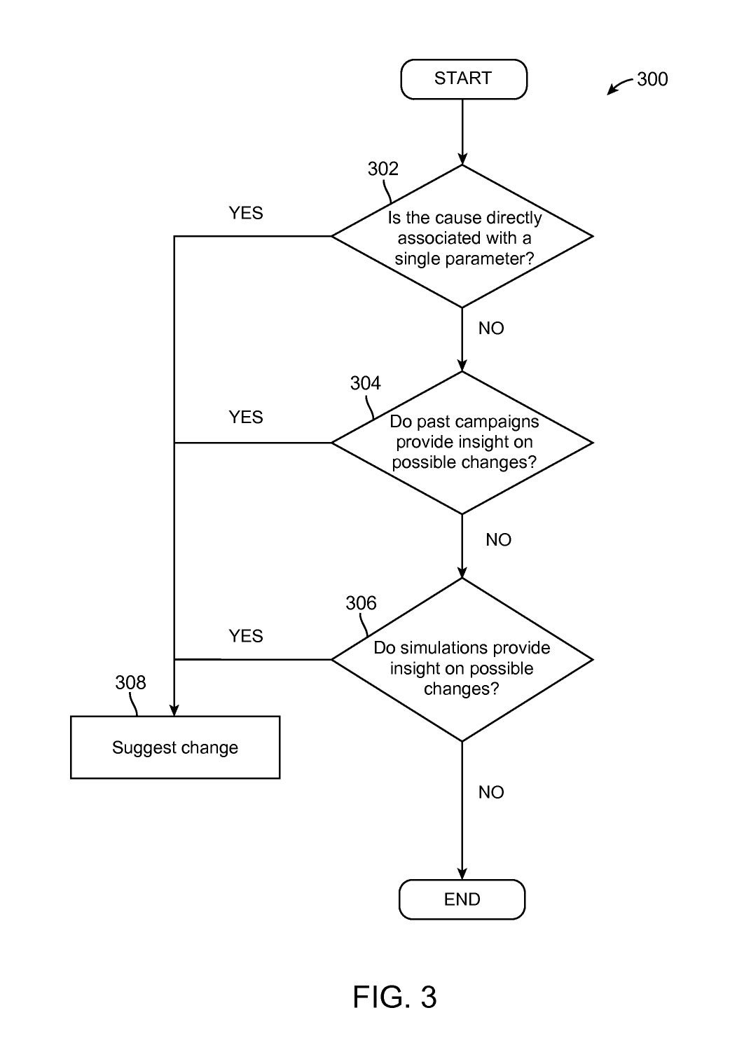

The content of the alert can vary with the configuration of the delivery system 106. In some embodiments, the alert can indicate the source that was determined to be the cause of the non-conformance. In some embodiments, the alert can suggest how to improve the performance. For example, if the delivery system 106 determines that the non-conformance is the result of using an overly narrow targeted segment, the alert could suggest the use of a broader targeted segment or suggest a way to customize the segment that might make it more effective. FIG. 3 is a flow chart illustrating steps in an exemplary method 300 for suggesting changes that may lead to improved campaign performance for a non-conforming campaign. In formulating a suggestion to improve performance, the delivery system 106 can check if the identified cause of the non-conformance is associated with a single parameter (302). For example, the associated targeted segment is too narrow or too broad or the specified performance criteria are unrealistic. If the cause is associated with a single parameter, the delivery system 106 can make a suggestion based on a tweak of that parameter (308). The particular change necessary can be based on past performance data, simulation data, or simple comparison with an expected result. For example, if the cause of the non-conformance is that a parameter is set too narrowly/broadly or low/high, the delivery system 106 can suggest a change in opposite direction. If the delivery system 106 can identify the exact tweak necessary, the necessary change can be included in the alert. However, if the delivery system is only able to identify which parameter should be changed, only that information can be included in the alert.

The delivery system 106 can also look to past campaigns to provide insight on possible changes that could improve performance (304). For example, if the non-conforming campaign is similar to a past well performing campaign, the delivery system 106 could suggest changes to the parameters associated with the delivery system or the campaign that brings the non-conforming campaign more in line with the well performing campaign (308). The suggested changes can be included in the alert to the appropriate entity.

The delivery system 106 can also perform various simulations to provide insight on possible changes that could improve performance (306). These simulations could involve tweaking different parameters of the system or the campaign and then estimating future performance. If the estimated future performance is an improvement on the current campaign performance, the delivery system 106 could suggest those changes in the alert (308). Although specific considerations for formulating a suggestion that could improve performance are shown in FIG. 3, in other embodiments, different considerations can be made.

In some embodiments, additional details can be included in the alert. For example, in some cases, it may be useful for an alert to a system administrator to include a detailed report of the non-conforming campaign and/or cause of the non-conformance. This report can include statistics, metrics, and even graphs of various aspects and analyses of the performance data. If a fix is suggested in the alert, a detailed report can be used to conduct an independent evaluation to confirm that the suggested fix is a correct solution and/or to determine if other adjustments can also be made to improve performance.

The form of the alert can vary depending on the configuration of the delivery system 106 and/or the intended recipient of the alert. For example, if the intended recipient is an administrator of the delivery system 106, the alert can take the form of a message displayed to the screen like a pop-up window. Alternatively, the alert can be delivered via an electronic message such as email. This form of alert can be used whether the intended recipient is an administrator of the delivery system 106 or a content provider 110. An electronic message could also be delivered to the account of the content provider responsible for submitting the under-performing campaign. When the content provider logs in to submit new campaigns or make adjustments to current campaigns, the message could be available for viewing. The alert could take the form of an automated telephone message.

In some embodiments, different forms of alerts can be used for different parameters. For example, the automated phone message can be used for highly critical performance data, while an email message could be used for a less critical notification. In some embodiments, different forms of alerts can be used at different times. For example, if an administrator is currently logged in and monitoring the system, a pop-up message can be an appropriate means of providing notice regarding non-conformance. However, if an administrator is not currently monitoring the delivery system 106 then a pop-up message could go unnoticed, instead an automated phone message or email message may be a better method of notification. In some embodiments, multiple forms of alert can be used. For example, a pop-up alert as well as an email alert could be generated. Alternatively, the different forms of alert could serve an escalating purpose. For example, the automated telephone message form of alert could be used as a back-up alert, such as when other alerts have been generated but no action has been taken to improve the performance.

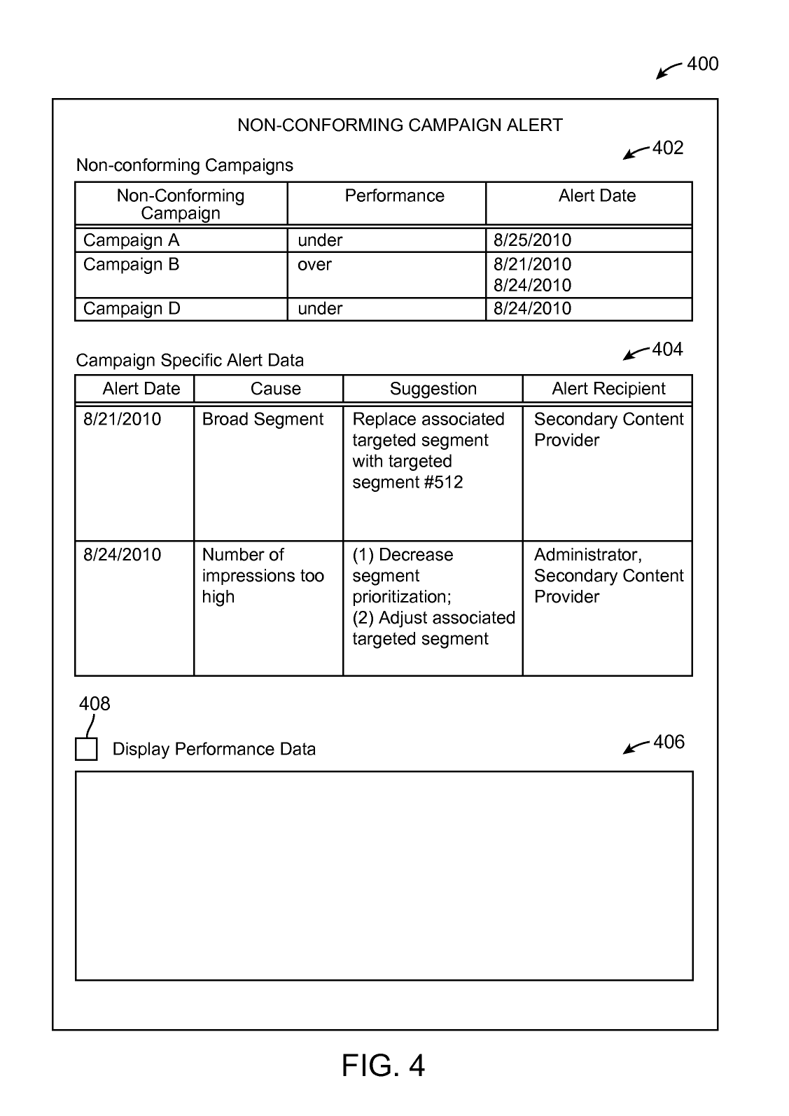

FIG. 4 shows an exemplary user interface (UI) 400 for a non-conforming campaign alert. The UI 400 can be directed at the administrator of the delivery system to provide information regarding campaigns that are currently non-conforming. The UI 400 can include three sections of information: (1) a table 402 of non-conforming campaigns, (2) a table 404 of campaign specific alert data; and (3) a window 406 for viewing campaign specific performance data. In some embodiments, different configurations of the data and/or different information can be included in the UI 400.

Table 402 can include information regarding the identity of the non-conforming campaign, the performance status (i.e. under- or over-performing), and the date on which non-conformity was detected. The granularity for the alert date can very with the configuration of the system. For example, if the delivery system 106 is configured to evaluate campaign performance once a day, the alert date may only specify the month, day, and year. However, if the delivery system 106 is configured to evaluate campaign performance every 6 hours, the alert date may include the month, day, year, and time. In some embodiments, the granularity of the alert date can be independent of the campaign performance evaluation schedule. For example, the delivery system 106 may evaluate the performance every 12 hours, but the alert date may only include the month, day, and year. Additionally, more than one alert date can be recorded. This could be useful if a campaign was detected as non-conforming for one reason, and that non-conformity has not been addressed before a new reason is detected. This particular scenario is illustrated in table 402 for Campaign B, which has two alert dates.

Any number of non-conforming campaigns can be included in the display. In some configurations, the amount of the space used by the table can be increased to accommodate additional non-conforming campaigns. A scroll bar can also be used to accommodate additional non-conforming campaigns. Additional configurations are also possible. In some configurations, the table 402 can be sorted based on different criteria. For example, the table 402 could be sorted by an alphabetical listing of non-conforming campaigns, by performance, or in ascending order by alert date, etc.

Table 404 can display information specific to a particular non-conforming campaign. In some configurations, the table 404 can be populated by selecting a particular non-conforming campaign from the list in table 402. Table 404 can include the alert date, the cause of the non-conformity, a suggested change that could alter the campaign to better achieve the specified performance criteria, and the alert recipient. In some configurations, the table 404 may not include a suggestion.

Table 404 is illustrated using campaign specific alert data for Campaign B from Table 402. Campaign B has two alert dates, and each of those alerts has a single cause; however, in some cases, multiple causes can be associated with a single alert date. In table 404, the cause associated with alert date 8/21/2010 is displayed because it is still a valid cause of the non-conformity. However, the cause is not duplicated for alert date 8/24/2010. In this configuration, the delivery system 106 only displays unique causes so as to minimize the number of alerts, but other configurations are also possible.

Table 404 also illustrates that multiple recipients can be associated with a single alert cause. For example, an alert for alert date 8/24/2010 was generated for both an administrator of the delivery system 106 and the secondary content provider that submitted the non-conforming campaign. In some configurations, if multiple suggestions are made by the delivery system 106, a different alert message can be sent to the different recipients. For example, for the alert associated with alert date 8/24/2010, the suggestion to decrease segment prioritization could be sent to the administrator of the delivery system 106. Such a suggestion may not be useful for the content provider, and thus may not need to be included in the alert for the content provider. However, the suggestion of adjusting the associated targeted segment is likely useful for the content provider, so the alert generated for the content provider could include this information. Additionally, the alert for the administrator could include the suggestion related to the targeted segment. In some configurations, the inclusion of a suggestion directed at a content provider can be included in an alert for an administrator, or some other entity such as a sales associate, after the non-conformity has gone unaddressed for a specified period of time. In some configurations, a suggestion for a content provider can always be included in an alert for another entity, e.g. administrator or sales associate.

In some configurations, window 406 for viewing campaign specific performance data can be populated with all performance data for a non-conforming campaign selected from table 402. The displayed performance data can also be customized or narrowed, for example, by selecting a particular alert date from table 404. Other methods of customizing the performance data displayed are also possible. In some configurations, the performance data can be displayed as text, graph, figures, etc. Additionally, in some configurations, the display of the performance data can be toggled by checking or un-checking the check box 408.

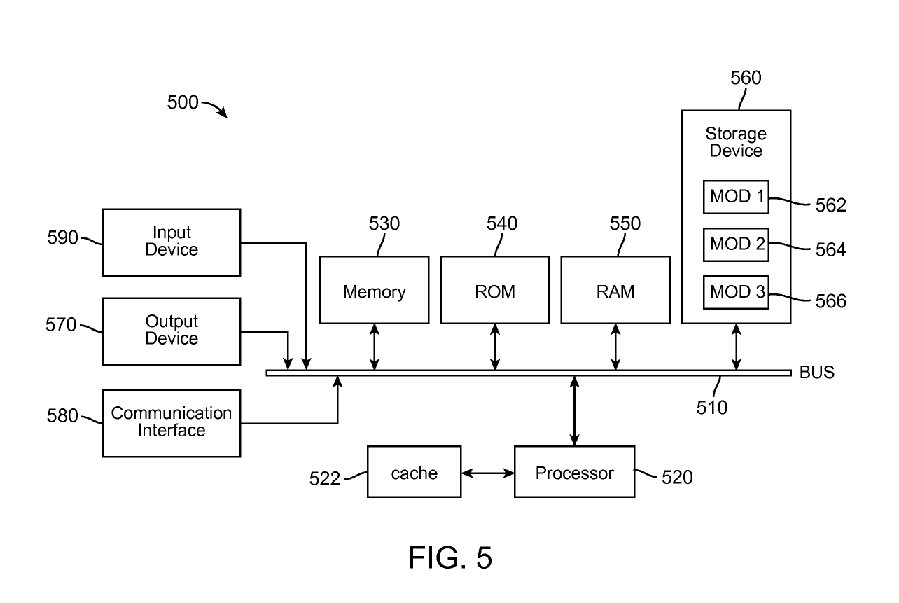

With reference to FIG. 5, an exemplary system 500 includes a general-purpose computing device 500, including a processing unit (CPU or processor) 520 and a system bus 510 that couples various system components, including the system memory 530, such as read only memory (ROM) 540 and random access memory (RAM) 550 to the processor 520. The system 500 can include a cache 522 of high speed memory connected directly with, in close proximity to, or integrated as part of the processor 520. The system 500 copies data from the memory 530 and/or the storage device 560 to the cache 522 for quick access by the processor 520. In this way, the cache 522 provides a performance boost that avoids processor 520 delays while waiting for data. These and other modules can be configured to control the processor 520 to perform various actions. Other system memory 530 may be available for use as well. The memory 530 can include multiple different types of memory with different performance characteristics. It can be appreciated that the disclosure may operate on a computing device 500 with more than one processor 520, or on a group or cluster of computing devices networked together to provide greater processing capability. The processor 520 can include any general purpose processor and a hardware module or software module, such as module 1 562, module 2 564, and module 3 566 stored in storage device 560, configured to control the processor 520 as well as a special-purpose processor where software instructions are incorporated into the actual processor design. The processor 520 may essentially be a completely self-contained computing system, containing multiple cores or processors, a bus, memory controller, cache, etc. A multi-core processor may be symmetric or asymmetric.

The system bus 510 may be any of several types of bus structures including a memory bus or memory controller, a peripheral bus, and a local bus using any of a variety of bus architectures. A basic input/output (BIOS) stored in ROM 540 or the like, may provide the basic routine that helps to transfer information between elements within the computing device 500, such as during start-up. The computing device 500 further includes storage devices 560, such as a hard disk drive, a magnetic disk drive, an optical disk drive, tape drive or the like. The storage device 560 can include software modules 562, 564, 566 for controlling the processor 520. Other hardware or software modules are contemplated. The storage device 560 is connected to the system bus 510 by a drive interface. The drives and the associated computer readable storage media provide nonvolatile storage of computer readable instructions, data structures, program modules and other data for the computing device 500. In one aspect, a hardware module that performs a particular function includes the software component stored in a non-transitory computer-readable medium in connection with the necessary hardware components, such as the processor 520, bus 510, display 570, and so forth, to carry out the function. The basic components are known to those of skill in the art, and appropriate variations are contemplated depending on the type of device, such as whether the device 500 is a small, handheld computing device, a desktop computer, or a computer server.

Although the exemplary embodiment described herein employs the hard disk 560, it should be appreciated by those skilled in the art that other types of computer readable media which can store data that are accessible by a computer, such as magnetic cassettes, flash memory cards, digital versatile disks, cartridges, random access memories (RAMs) 550, read only memory (ROM) 540, a cable or wireless signal containing a bit stream and the like, may also be used in the exemplary operating environment. Non-transitory computer-readable storage media expressly exclude media such as energy, carrier signals, electromagnetic waves, and signals per se.

To enable user interaction with the computing device 500, an input device 590 represents any number of input mechanisms, such as a microphone for speech, a touch-sensitive screen for gesture or graphical input, keyboard, mouse, motion input, speech and so forth. An output device 570 can also be one or more of a number of output mechanisms known to those of skill in the art. In some instances, multimodal systems enable a user to provide multiple types of input to communicate with the computing device 500. The communications interface 580 generally governs and manages the user input and system output. There is no restriction on operating on any particular hardware arrangement, and therefore the basic features here may easily be substituted for improved hardware or firmware arrangements as they are developed.

For clarity of explanation, the illustrative system embodiment is presented as including individual functional blocks including functional blocks labeled as a “processor” or processor 520. The functions these blocks represent may be provided through the use of either shared or dedicated hardware, including, but not limited to, hardware capable of executing software and hardware, such as a processor 520, that is purpose-built to operate as an equivalent to software executing on a general purpose processor. For example, the functions of one or more processors presented in FIG. 5 may be provided by a single shared processor or multiple processors. (Use of the term “processor” should not be construed to refer exclusively to hardware capable of executing software.) Illustrative embodiments may include microprocessor and/or digital signal processor (DSP) hardware, read-only memory (ROM) 540 for storing software performing the operations discussed below, and random access memory (RAM) 550 for storing results. Very large scale integration (VLSI) hardware embodiments, as well as custom VLSI circuitry in combination with a general purpose DSP circuit, may also be provided.

The logical operations of the various embodiments are implemented as: (1) a sequence of computer implemented steps, operations, or procedures running on a programmable circuit within a general use computer, (2) a sequence of computer implemented steps, operations, or procedures running on a specific-use programmable circuit; and/or (3) interconnected machine modules or program engines within the programmable circuits. The system 500 shown in FIG. 5 can practice all or part of the recited methods, can be a part of the recited systems, and/or can operate according to instructions in the recited non-transitory computer-readable storage media. Such logical operations can be implemented as modules configured to control the processor 520 to perform particular functions according to the programming of the module. For example, FIG. 5 illustrates three modules Mod1 562, Mod2 564 and Mod3 566, which are modules controlling the processor 520 to perform particular steps or a series of steps. These modules may be stored on the storage device 560 and loaded into RAM 550 or memory 530 at runtime, or may be stored, as would be known in the art, in other computer-readable memory locations.

Embodiments within the scope of the present disclosure may also include tangible and/or non-transitory computer-readable storage media for carrying or having computer-executable instructions or data structures stored thereon. Such non-transitory computer-readable storage media can be any available media that can be accessed by a general purpose or special purpose computer, including the functional design of any special purpose processor as discussed above. By way of example, and not limitation, such non-transitory computer-readable media can include RAM, ROM, EEPROM, CD-ROM or other optical disk storage, magnetic disk storage or other magnetic storage devices, or any other medium which can be used to carry or store desired program code means in the form of computer-executable instructions, data structures, or processor chip design. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Those of skill in the art will appreciate that other embodiments of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

The various embodiments described above are provided by way of illustration only and should not be construed to limit the scope of the disclosure. Those skilled in the art will readily recognize various modifications and changes that may be made to the principles described herein without following the example embodiments and applications illustrated and described herein, and without departing from the spirit and scope of the disclosure.

1. A computer-implemented method, comprising:
obtaining a plurality of performance data associated with a selected time window for a plurality of elements in a network for distributing invitational content to a plurality of end user devices communicating on the network;
identifying at least one portion of the plurality of performance data failing to meet one or more performance criteria for the selected time window;
determining at least one of a plurality of parameters defined by the plurality of elements contributing to the identified portion and failing to meet a pre-defined criteria for the parameter; and
generating a notification for a one of the plurality of elements associated with the determined one of the plurality parameters, the notification indicating the failure to meet the pre-defined criteria.

2. The computer-implemented method of claim 1, wherein the at least one parameter comprises at least one among behavioral information parameters, operational data integrity parameters, feature rollout parameters, and partner-specific parameters.

3. The computer-implemented method of claim 1, further comprising computing the pre-defined criteria based on a projection of the plurality of performance data during the selected time window based on active electronic campaigns associated with the selected time window.

4. The computer-implemented method of claim 1, further comprising:
dividing the plurality of performance data into one or more sets of performance data based on at least one device characteristic for the plurality of end user devices; and
separately performing the steps of identifying, determining, and generating for each of the performance data sets.

5. The computer-implemented method of claim 1, wherein the step of determining further comprises:
obtaining a corpus of performance data associated with a plurality of time windows;
constructing a correlation data associating the plurality of parameters and the corpus of performance data; and
selecting the at least one of the plurality of parameters based on the correlation data.

6. A non-transitory computer-readable medium having code for causing a computer to perform a method stored thereon, the method comprising:
obtaining a plurality of performance data associated with a selected time window for a plurality of elements in a network for distributing invitational content to a plurality of end user devices;
identifying at least one portion of the plurality of performance data failing to meet one or more performance criteria for the selected time window;
selecting at least one of the plurality of elements defining one or more parameters associated with the identified portion;
determining a correlation between the parameters defined by the selected one of the plurality of elements and the identified portion based on a plurality of performance data associated with a plurality of time windows; and
generating a notification for the selected one of the plurality of elements, the notification proposing a change in the at least one of the parameters to improve performance data during a future time window, wherein the proposed change is based on the correlation.

7. The non-transitory computer-readable medium of claim 6, wherein the at least one parameter comprises at least one among behavioral information parameters, operational data integrity parameters, feature rollout parameters, and partner-specific parameters.

8. The non-transitory computer-readable medium of claim 6, further comprising computing the pre-defined criteria based on a projection of the plurality of performance data during the selected time window based on active electronic campaigns associated with the selected time window.

9. The non-transitory computer-readable medium of claim 6, further comprising:
dividing the plurality of performance data into one or more sets of performance data based on at least one user device characteristic associated with the plurality of end user devices; and
separately performing the steps of identifying, selecting, determining, and generating for each of the performance data sets.

10. The non-transitory computer-readable medium of claim 6, wherein the step of determining further comprises:
obtaining a corpus of performance data associated with a plurality of time windows;
constructing a correlation data associating the plurality of parameters and the corpus of performance data; and
selecting the at least one of the plurality of parameters based on the correlation data.

11. A network monitoring system, comprising:
a storage element for receiving a plurality of performance data associated with a selected time window for a plurality of elements in a network for distributing invitational content to a plurality of end user devices; and
a processing element communicatively coupled to the storage element, wherein the processing element is configured for identifying at least one portion of the plurality of performance data failing to meet one or more performance criteria for the selected time window, determining at least one of a plurality of parameter defined by the plurality of elements contributing to the identified portion and failing to meet a pre-defined criteria for the parameter, and generating a notification for one of the plurality of elements associated with the determined one of the plurality parameters indicating the failure to meet the pre-defined criteria.

12. The network monitoring system of claim 11, wherein the at least one parameter comprises at least one among behavioral information parameters, operational data integrity parameters, feature rollout parameters, and partner-specific parameters.

13. The network monitoring system of claim 11, wherein the processing element is further configured for computing the pre-defined criteria based on a projection of the plurality of performance data during the selected time window based on active electronic campaigns associated with the selected time window.

14. The network monitoring system of claim 11, wherein the processing element is further configured for dividing the plurality of performance data into one or more sets of performance data based on at least one user device characteristic, and performing the identifying, determining, and generating separately for each of the performance data sets.

15. The network monitoring system of claim 11, wherein the storage element is further configured for storing a corpus of performance data associated with a plurality of time windows, and wherein the processing element is further configured for determining the correlation by constructing a correlation data associating the plurality of parameters and the corpus of performance data and selecting the at least one of the plurality of parameters based on the correlation data.

16. A network monitoring system, comprising:
at least one processing element;
a first module for causing the processing element to obtain a plurality of performance data associated with a selected time window for a plurality of elements in a network for distributing invitational content;
a second module for causing the processing element to identify at least one portion of the plurality of performance data failing to meet one or more performance criteria for the selected time window and at least one of the plurality of elements defining one or more parameters associated with the identified portion;
a third module for causing the processing element to determine a correlation between the parameters defined by the selected one of the plurality of elements and the identified portion based on a plurality of performance data associated with a plurality of time windows; and
a fourth module for causing the processing element to generate a notification for the selected one of the plurality of elements, the notification proposing a change in the at least one of the parameters defined by the selected one of the plurality of elements to improve performance data during a future time window, and wherein the proposed change is based on the correlation.

17. The network monitoring system of claim 16, wherein the at least one parameter comprises at least one among behavioral information parameters, operational data integrity parameters, feature rollout parameters, and partner-specific parameters.

18. The network monitoring system of claim 16, further comprising a fifth module for causing the processing element to compute the pre-defined criteria based on a projection of the plurality of performance data during the selected time window based on active electronic campaigns associated with the selected time window.

19. The network monitoring method of claim 16, wherein the first module is further configured for causing the processing element to retrieve a portion the plurality of performance data associated with on at least one user device characteristic.

20. The network monitoring system of claim 16, wherein the third module is further configured for causing the processing element to obtain a corpus of performance data associated with a plurality of time windows, construct a correlation data associating the plurality of parameters and the corpus of performance data, and select the at least one of the plurality of parameters based on the correlation data.

21. A computer-implemented method, comprising:
obtaining a plurality of performance data associated with a selected time window for a plurality of elements in a network for distributing invitational content to a plurality of end user devices;
identifying at least one portion of the plurality of performance data failing to meet one or more performance criteria for the selected time window;
determining at least one of a plurality of parameters defined by the plurality of elements contributing to the identified portion; and
generating a notification for at least one of the plurality of elements associated with the determined one of the plurality parameters,
wherein the notification comprises at least one of a failure of the determined one of the plurality of parameters to meet the pre-defined criteria and a proposed change for the determined one of the plurality of parameters.

22. The computer-implemented method of claim 21, wherein the step of generating further comprises:
selecting at least one of the plurality of elements associated with the identified portion;
determining a correlation between the parameters defined by the selected one of the plurality of elements and the identified portion based on a plurality of performance data associated with a plurality of time windows; and
computing the proposed change based on the correlation, wherein the proposed change is computed to provide improved performance data during a future time interval.

23. The computer-implemented method of claim 22, wherein the at least one parameter comprise at least one among behavioral information parameters, operational data integrity parameters, feature rollout parameters, and partner-specific parameters.
